(19) United States
(12) Patent Application Publication
(10) Pub. No.: US 2019/0023178 A1
(43) Pub. Date: Jan. 24, 2019

(54) Car Body Element Comprising An Illuminating Device With A Diffusing Light Guide

(71) Applicant: Compagnie Plastic Omnium, Lyon (FR)

(72) Inventor: Issam Khayat, 69001 Lyon (FR)

(21) Appl. No.: 15/757,520

(22) PCT Filed: Sep. 2, 2016
(86) PCT No.: PCT/FR2016/052172

§ 371 Date: Mar. 5, 2018

(30) Foreign Application Priority Data
Sep. 4, 2015 (FR) 1558197

(51) Int. Cl. B60Q 1/56; F21S 41/24; F21S 41/141; B60Q 1/00; E05F 13/00; B60J 5/10

(52) U.S. Cl. CPC B60Q 1/56; F21S 41/24; F21S 41/141; B60Q 1/0017; E05Y 2900/546; B60J 5/107; E05Y 2400/44; E05Y 2400/852; E05F 13/00

(57) ABSTRACT

A car body element which forms an outer surface of an automobile includes a device for illuminating the license plate, characterised in that the illumination device includes a diffusing light guide connected to a light source and formed by a plurality of optical fibres arranged to form sheets, such that the illumination device emits a luminous flux at all points of an illuminating part of the diffusing light guide.

### FIELD OF THE INVENTION

The object of the invention is a car body, or a car body element in which a stylistic effect is sought.

### BACKGROUND OF THE INVENTION

The car body is formed by all of the elements forming the outer surface of the car, which are generally visible from outside the car, and which overall contribute to the general outer shape and style of the car.

In order to highlight certain parts of the car body, the designers may create recesses appearing as locally concave zones, varying in contour and length, having a shape generally stretched along a main direction, oriented vertically or horizontally according to the sought-after effect.

When their shape is emphasized, they can also have a functional aspect and act as a housing for a specific item of equipment, or allow manual grasping of the car body element on which they are integrated. This is the case for example, but not exclusively, of the recess situated on the tailgate of the car and which acts as a handle for opening the tailgate.

So, in respect of the object of the invention and of the present description, recess means an inward fold with an elongated shape, made on the surface of the car body by one or more elements forming an integral part of the car body, and in which at least a part of the recessed zone is situated facing another part of the car body adjacent to this recess. The recess locally overhangs the car body.

In order to emphasize the stylistic effect procured by these recesses, it may appear judicious to arrange an illumination device inside the recess, allowing a luminous flux to be emitted along the stylistic line formed by said recess. This illumination can also have a functional aspect when placed facing a zone to be made visible such as a license plate or a door handle.

Publication DE 102004031796 describes an illumination device comprising a light guide for illuminating the surface of a motor vehicle body. When the surface to be illuminated is large, as is the case when seeking to illuminate a license plate, the light guide is made of a molded plastic material comprising faces for emitting the light.

However, this device has disadvantages when the surface to be illuminated is exposed to mechanical stress or shocks likely partially to damage the illumination device, then depriving the motor vehicle of illumination in places where this illumination is imposed by law, as can happen in the case of a position light or the illumination of a license plate.

Furthermore, the space requirement of the light guide can deprive the motor vehicle designer of possibilities of integrating the illumination device with other components such as the control device for opening a tailgate.

Finally, the practical embodiment of this molding and the integration in the motor vehicle of a piece of significant length pose a certain number of problems in connection with risks of rupture and deterioration of the surface condition.

### SUMMARY OF THE INVENTION

The invention, whose object is to bring an original solution to the problems posed above concerns a car body element, which forms an outer surface of a motor vehicle and comprises a device for illuminating a license plate.

This illumination device is characterized in that it comprises a diffusing light guide connected to a light source and formed by a plurality of optical fibers arranged in sheets, such that the illumination device emits a luminous flux at all points of an illuminating part of said diffusing light guide.

Optical guide or light guide here means a transparent or translucent piece inside which luminous rays move in a controlled manner along a common general direction from a first end of the guide including an inlet surface near which one or more light sources are arranged, to an outlet surface from which the luminous rays emerge.

The propagation of the light inside the light guide takes place by successive internal reflections of the luminous rays on the faces of the light guide called internal reflection faces.

The outlet surface can be formed by the face or section opposite the inlet face, or alternatively by a lateral face of the light guide.

In the present description, and in a manner known to the person skilled in the art, diffusing light guide means a light guide in which the outlet surface of the light is formed by a lateral face of said light guide. This surface, which occupies all or part of the surface of the light guide, is generally substantially parallel to the general direction of the light guide. Thus, for a diffusing light guide having a circular straight cross-section, such as an optical fiber, the light emerges from the light guide in a substantially radial direction. A diffusing light guide therefore allows a substantially constant luminous flux to be distributed to any point of the outlet surface of the diffusing part of the guide, forming the illuminating part.

The embodiment of a diffusing light guide can call upon different technologies, known per se. A first technique consists of treating the surface of the fiber to make it rough. The rough parts then constitute the same number of reflection surfaces allowing a part of the light to escape from the light guide to the exterior. This technology is not very onerous and proves to be very effective for diffusing light guides of small length, in practice for lengths of less than 3 m. It also allows only the part of the light guide that is used for illumination and that forms here the illuminating part to be made to diffuse.

Another technology consists of doping the material forming the light guide by means of microscopic reflecting particles. This technology makes it possible to make the diffusion of the light more uniform.

The untreated and hence non-diffusing part of the optical fibers serves to conduct the light without loss from the light source to the diffusing part, organized as a sheet.

The stylistic effect obtained by means of a diffusing illumination device arranged above the license plate therefore makes it possible to create a luminous halo distributed evenly all along the illuminating part.

The use of optical fibers of small diameter makes it possible to create a sheet supplying a uniform luminous flux with sufficient intensity over the entire length of the license plate.

In the event of shock or any other unforeseen mechanical action, only one or two fibers can be damaged. But the illumination of the license plate remains assured by the other optical fibers of the sheet, so that the motor vehicle can continue on its route in total safety.

This disseminated surface illumination can also prove to be particularly useful for illuminating or indicating the location of a functional element situated in or near the license plate. This is the case for example of the control device for opening a tailgate, whose presence it may seem judicious to signal by a luminous line, as well as the zone along which this opening control device extends.

Furthermore, and as will be seen subsequently, the low space requirement of the device according to the invention allows the illumination device and the opening control device to be assembled on a common support.

The car body according to the invention can also comprise the following features, in isolation or combined:
The diffusing light guide is arranged on a support.
The support is formed by extrusion or by molding from a thermoplastic or elastomeric material, preferably flexible.
The support has a substantially cylindrical shape, and the optical fibers are arranged along the generatrices.
The diffusing light guide is placed in a recess such that the luminous flux is directed only towards the surface of the body of said motor vehicle adjacent to said recess, and to which surface the license plate is fastened.
The illuminating part of the light guide extends transversally over a length equal to or greater than the length of said license plate, such that said license plate receives a constant luminous flux over its entire length.
The optical fibers have a diameter of less than 1 mm, and preferably less than or equal to 0.5 mm.
The diffusing light guide is connected at one of its ends to one or more light sources situated on an inner side of the car body element.
The recess comprises a single orifice through which the diffusing light guide passes from the inner side of the car body element to an outer side of said car body element.
The light source is formed by one or more light emitting diodes.
The car body element furthermore comprises an opening control device situated in said recess, and extending transversally over the entire length of the illumination device such that said opening control can be actuated at any point of a segment illuminated by the illumination device.
The opening control device is assembled on the support.
The opening control device is of resistive or acoustic type, or preferably of optical type, or even more preferably of capacitive type.
The opening control device of capacitive type is assembled towards the inner part of the car body element, and the material forming said car body element is permeable to electromagnetic fields.
The car body element is formed by a motor vehicle tailgate.

### BRIEF DESCRIPTION OF THE DRAWINGS

The invention will be better understood on reading the attached figures, which are supplied as examples and have no limitative character, in which:

FIG. 1 shows a motor vehicle tailgate including a first recess situated above the license plate.

FIG. 2 is a sectional view along A-A of the tailgate.

FIG. 3 diagrammatically shows a perspective view of a support on which the diffusing illumination device is arranged.

FIG. 3a shows optical fibers arranged as a sheet.

FIG. 4 shows a sectional view along A-A of a diffusing illumination device combined with a capacitive effect opening control device.

FIG. 5 shows a sectional view along A-A of an illumination device according to an implementation variant of the device of FIG. 4.

FIG. 6 shows a sectional view along A-A of an illumination device combined with an optical effect opening control device.

FIG. 6a shows a diagrammatic sectional view of an optical effect control device.

FIG. 7 shows a sectional view along A-A of an illumination device combined with an acoustic effect opening control device.

FIG. 7a shows a diagrammatic sectional view of an acoustic effect control device.

FIG. 8 shows a sectional view along A-A of an illumination device combined with a resistive effect opening control device.

FIG. 8a shows a diagrammatic sectional view of a resistive effect control device.

FIG. 9 shows a motor vehicle tailgate including a second recess situated below the rear window.

FIG. 10 shows a sectional view along B-B of an illumination device situated in the recess illustrated in FIG. 9.

### DESCRIPTION OF THE PREFERRED EMBODIMENTS

The car body element used to support the present description is formed, in a non-limitative manner, by the tailgate 15 of the motor vehicle.

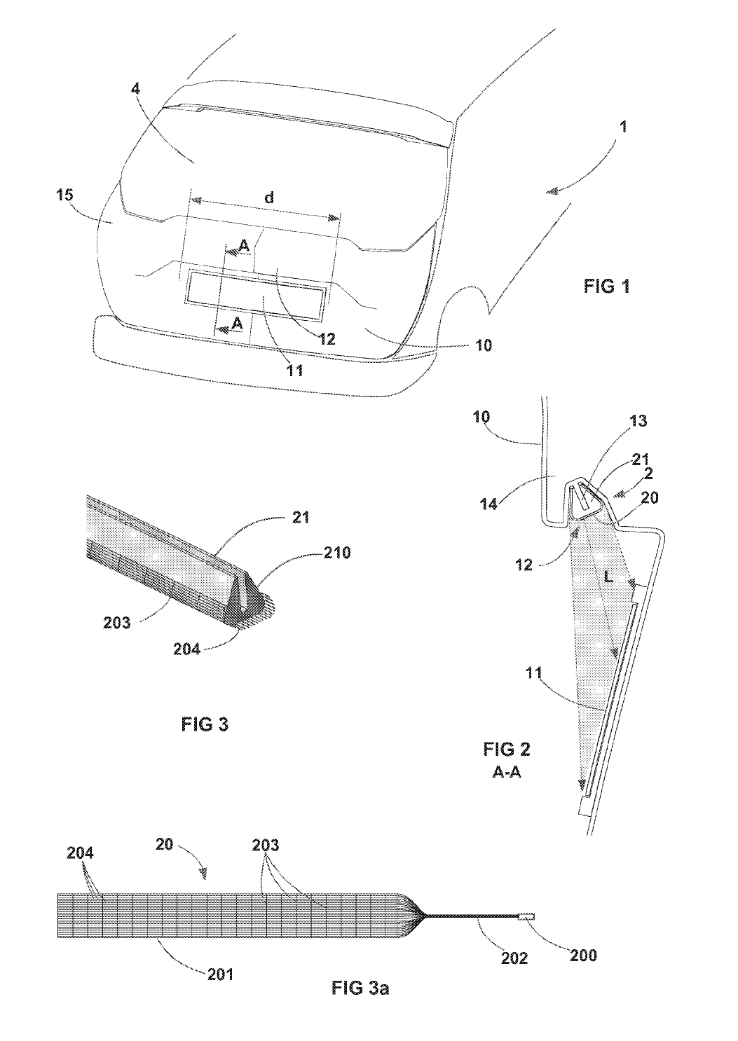

The panel 10, forming the outer side of the car body element seen from outside, and the window 4 of the part of the car body 1 formed by the tailgate 15, and illustrated in FIG. 1, thus contribute to the general style of the motor vehicle.

A first horizontal recess 12 is made in the part of the tailgate 15 situated above the license plate 11. This recess extends transversally over a length d greater than or equal to the length of the license plate 11.

The recess 12 locally overhangs the part of the car body that supports the license plate 11.

The section along A-A, illustrated in FIG. 2, makes it possible better to visualize the part of the tailgate 15 that includes the recess 12.

An illumination device 2 is arranged in the recess 12. This illumination device comprises a diffusing light guide 20 formed by optical fibers arranged as a sheet.

The sheet of optical fibers, visible in FIG. 3a, consists of sections of fibers 204 substantially rectilinear and parallel to each other. This sheet can include weft threads 203 ensuring good mechanical strength of the assembly.

It is possible to distinguish the illuminating part 201 in which the optical fibers 204 emit a diffusing light in the radial direction, and the non-diffusing part 202 allowing the illuminating part of the sheet 201 to be connected to the light source 200 preferably formed by a light emitting diode.

The optical fibers 204 are made by extrusion using a plastic material such as PMMA or potentially glass. The fibers have a reduced diameter so as to increase the flexibility of the sheet and assist its implantation on the support 21. The diameter of a fiber is less than 1 mm and preferably less than or equal to 0.5 mm.

The number and the nature of the optical fibers make it possible to adjust the power of the luminous flux. A sheet of glass fibers including about twenty fibers, 0.5 mm in diameter, procures a very satisfactory luminous effect.

FIG. 3 makes it possible to visualize the shape of the support 21 on which the sheet of optical fibers is arranged.

The support 21 has a generally cylindrical shape whose straight section 210 is adapted to allow the assembly of said support on the car body element. In the present case, the support 21 is arranged on a fastening rail 13 by simple bonding or by interlocking or by simple clipping.

Alternatively, the sheet of optical fibers 20 can be assembled to the car body element by a detachable fastening such as a system of the Velcro™ type, or by an adhesive strip, interposed between the surface of the sheet 20 and the surface of the car body element 10.

Due to the flexibility of the weft threads 203, the optical fibers 204 of the sheet are arranged along the generatrices of the cylinder formed by the support 21, such that the sheet is conformal with the general shape of the support 21. The fiber sheet can be bonded to the support 21 or held by being squeezed against the walls of the recess 12 when inserting the support 210 on the fastening rail 13.

Complementary to the means described above, it is possible to provide a locking means, such as a screw, in order to ensure the inviolability of the device and prevent the illuminating device from being dismantled from outside the motor vehicle.

The support 21 can be made by injection or by extrusion of an elastomer material, or of a thermoplastic material having properties of flexibility and elasticity and allowing good modularity in its use.

The diffusing part 201 of the optical fibers, which is arranged as a sheet, extends in the transversal direction all along the recess 12 over a length at least greater than the length of the license plate and preferably over the entire length of the recess 12.

The luminous flux L emanating from the sheet of diffusing fibers is directed exclusively in the direction of the surface of the car body and of the license plate, without ever directly reaching an outside observer, who perceives only the part of the luminous beam reflected by the car body and, in particular, without ever dazzling the driver of a vehicle traveling behind.

The illuminating device therefore allows, in addition to the stylistic effect making it possible to highlight the shape of the motor vehicle, the license plate to be illuminated in accordance with the law, so as to be able to read the alphanumerical information enabling the vehicle to be identified when it is traveling in reduced luminosity conditions.

At this stage, it will be observed that the use of a light guide formed by a plurality of optical fibers also makes it possible to place the light source 200 arranged at the end of the light guide at any location on the inside of the car body, in a protected location, and to make only the diffusing part of the light guide emerge on the outside part of the car body through a single passage made in the recess.

The part 202 of the optical fibers routed inside the car body, and which is not diffusing, allows the light to travel with very slight dispersion from the light source 200 to the outer part 201 forming the sheet of fibers. The non-diffusing part of the fibers 202 is then gathered into a bundle with a small diameter and can pass through a single orifice with a small diameter from the outer part of the car body element to the inside of the car body, following a trajectory not necessarily rectilinear.

Optionally, the support 21 can advantageously comprise an appendage acting as a blanking plug for the orifice used as a passage for the bundle of fibers.

The arrangements described above make it possible to eliminate the use of protective glazing used in traditional technologies and which separate the emitting part of the light from the exterior of the motor vehicle, and to reduce attacks due to bad weather on the electrical part comprising the light source of the illuminating device.

When the recess 12 made in the car body also acts as a lifting handle, as is frequently the case when a tailgate 15 is involved, it may be advantageous to place an opening control device in the zone where the user will place their fingers to lift the tailgate 15.

Under the effect of the approach or the exercising of simple pressure on the part of the user, the control device authorizes unlocking of the lock closing the tailgate 15.

For reasons of convenience, it may be desirable to make the control device run over a significant length, equal to the length of said recess. This arrangement allows the user not to have to localize the precise location where they must place their fingers. The line of light emanating from the illuminating device then acts as an indicator for signaling to the user the extent of the zone in which they can operate in order simultaneously to control opening and lifting of the tailgate 15.

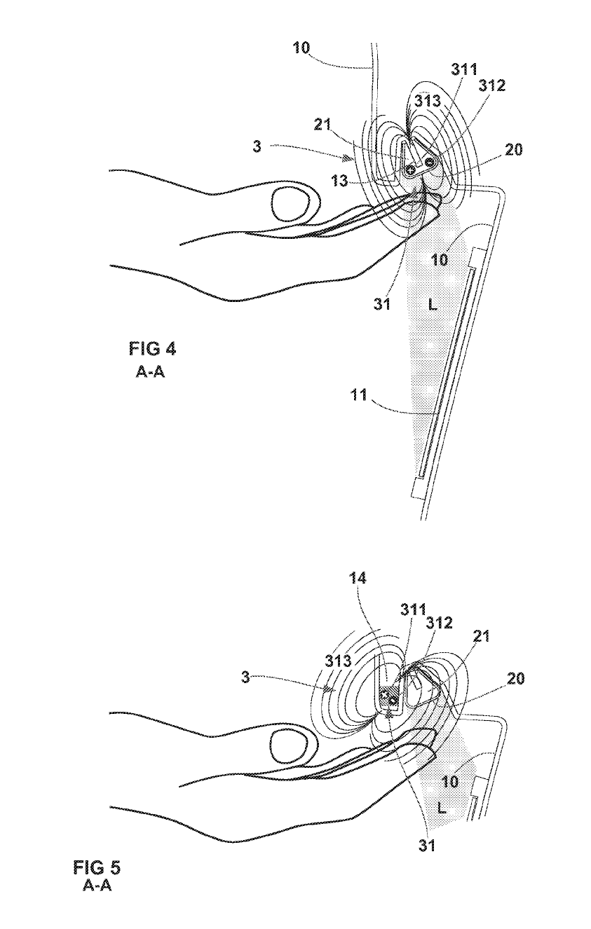

FIG. 4 makes it possible to illustrate the case of a capacitive effect opening control device 31. In this configuration, two polarized conductors 311 and 312 create an electromagnetic field in their near surroundings.

When the user's fingers penetrate the electromagnetic field, a sensor (not illustrated), sensitive to the change in capacitance, detects the change in the electromagnetic field and controls the opening of the tailgate 15.

There is no need at all to cause any physical contact between the user's fingers and the capacitive detector in order to activate the control. As a consequence of which, the conductors 311 and 312 may advantageously be arranged in the support 21 as shown in FIG. 4.

Alternatively, and provided that the car body is permeable to electromagnetic fields, the conductors 311 and 312 may be placed in an internal part of the car body 14, not visible from the outside and opposite the outer part 10, and arranged at the edge of the recess 12 as illustrated in FIG. 5. This arrangement allows all of the electrical functions to be arranged inside the car body.

Other embodiment alternatives are illustrated in the following figures.

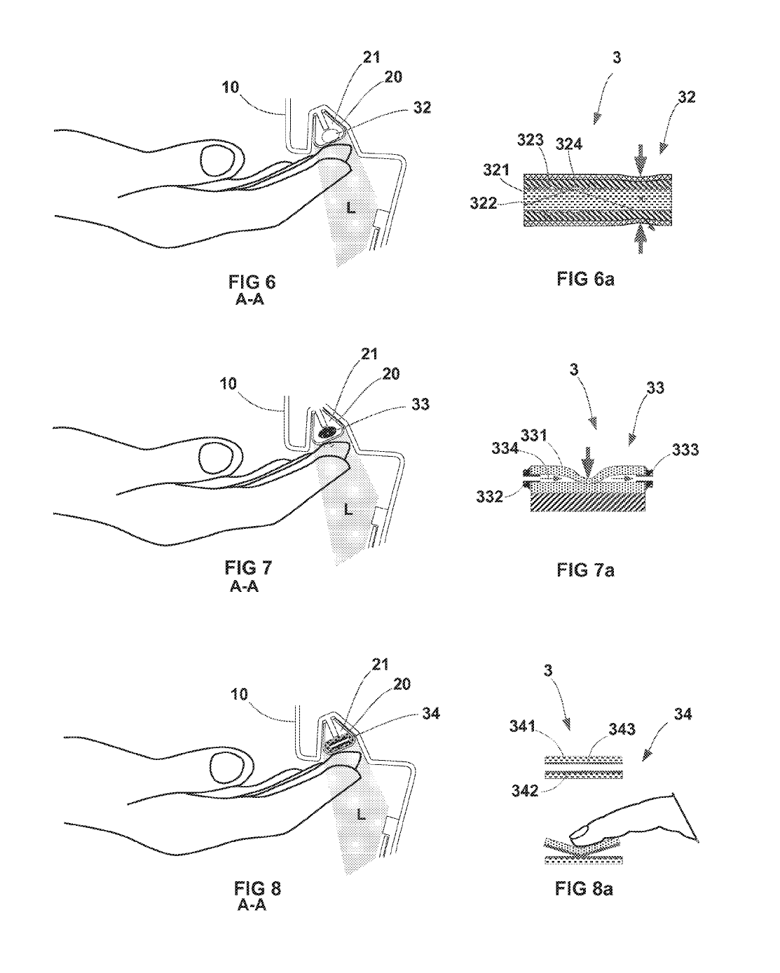

The device 32 for controlling by optical effect illustrated in FIGS. 6 and 6a is formed by an optical fiber 321, having a refractive index n₁, in which fiber a luminous ray 322 travels. The optical fiber is arranged inside a guide 323 having a refractive index n₃. The space 324 between the fiber 321 and the guide 323 forms an intermediate region having a refractive index n₂. The refractive indices are governed by the relation n₃>n₂>n₁. Under the effect of the pressure of the user's fingers, the guide 323 is pressed against the optical fiber 321 such that the luminous ray is no longer totally reflected by the optical fiber, and experiences an attenuation whose intensity can be evaluated by a control unit controlling the opening device (not illustrated).

FIG. 7 illustrates an alternative device 33 for controlling by acoustic effect. According to this technology, illustrated in FIG. 7a, the control device is formed by an elastic and deformable conduit 331. An acoustic wave emitter 332 having a determined power and frequency is placed at a first end of the tube, and an acoustic receiver 333 is arranged at the other end of the tube. When the conduit 331 is compressed under the effect of the pressure of a user's fingers, the acoustic wave 334 experiences attenuation, measurable by a detector (not illustrated) connected to the emitter and to the receiver. The detector then controls the lock to open.

Another alternative, illustrated in FIG. 8 provides a device 34 for controlling by resistive effect. This device, illustrated in FIG. 8a, is formed by two electrical conductors 341 and 342, isolated from each other and enclosed in an elastic and deformable conduit 343. A generator (not illustrated) maintains a difference of potential between the two conductors. When the deformable conduit experiences pressure, the conductors 341 and 342 come into contact or approach each other and change the resistivity of a circuit. A detector placed in the circuit assesses this change of resistivity and emits a control signal.

The control devices 32, 33 or 34 are sensitive to the pressure they experience locally. However, they can advantageously be placed inside the support 21 as long as the material constituting said support 21 is elastic and deformable so as to transmit the pressure exerted by the user's fingers to the opening control device.

The set of control devices described above therefore authorizes the opening of the tailgate 15 at any point situated along the luminous path highlighted by the illuminating device situated in the recess 12. The illuminating device and the opening control device may be arranged on the same support 21, the effect of which is to lighten the assembly operations of the components arranged on the tailgate 15. This option is particularly appreciated when the material forming the support 21 has a certain elasticity.

The stylistic effect mentioned in the above paragraphs is not limited only to the recess situated above the license plate and acting as a handle for lifting the tailgate 15.

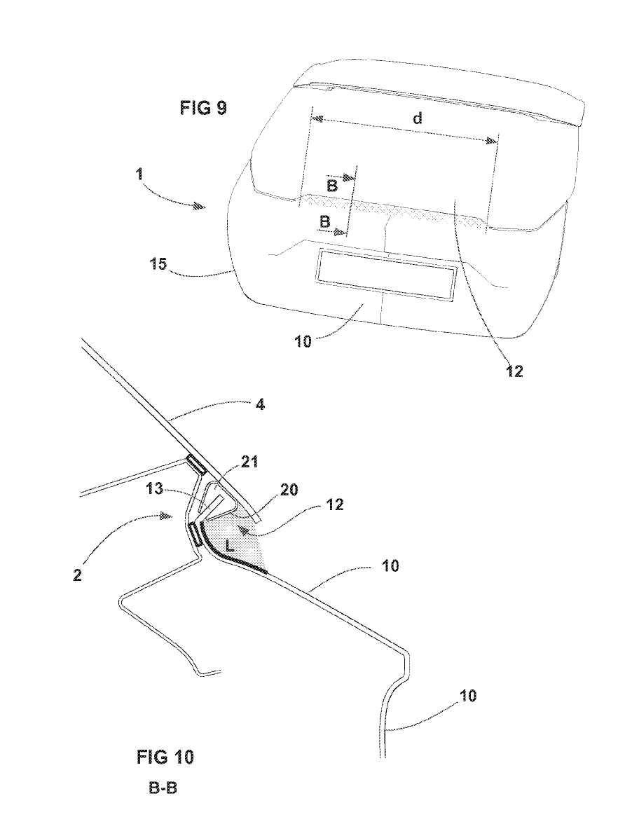

As an example, FIG. 9 therefore illustrates the case of a second type of recess 12 arranged on the tailgate 15, at the lower limit of the window 4.

FIG. 10 shows the sectional view along B-B, in which the lower part of the window 4 overspills slightly above the tailgate panel 10 to create a recess 12, inside which an illuminating device 2 according to the invention is accommodated.

Depending on the sought-after stylistic effect, or the degree of customization of the vehicle desired by its user, the color and the intensity of the luminous beam can be modulated by varying the color and the intensity of the light emitting diodes forming the light source and placed at one end of the diffusing light guide.

### NOMENCLATURE

1. Car body.
10. Outer surface of the car body (skin) situated on the outer side of the car body.
11 License plate.
12. Recess.
13 Rail for fastening the removable support.
14 Part situated on the inside of the car body, at the edge of the recess.
15 Tailgate.
2 Illuminating device.
20 Diffusing light guide formed by a plurality of small diameter optical fibers arranged as a sheet
200 Light emitting diode.
201 Sheet of optical fibers forming the illuminating part of the light guide.
202 Bundle of optical fibers.
203 Weft threads.
204 Optical fibers of the diffusing sheet.
21 Removable support.
210 Straight section of the removable support.
3 Opening control device.
31 Opening control device by capacitive effect.
311 and 312 Polarized conductors generating an electrical field.
313 Electrical field.
32 Opening control device by optical effect.
321 Opening control optical fiber.
322 Luminous ray.
323 Guide in which the optical fiber is arranged.
324 Space between the optical fiber and the guide.
33 Opening control device by acoustic effect.
331 Elastic and deformable conduit.
332 Acoustic wave emitter.
333 Acoustic wave receiver.
334 Acoustic wave.
34 Control device by resistive effect.
341 and 342 Electrical conductors.
4 Rear window.
L Luminous fluxed Length of the diffusing light guide situated on the outside of the car body.

1. A car body element, which forms an outer surface of an automobile comprises a device for illuminating a license plate, wherein, said illumination device comprises a diffusing light guide connected to a light source and formed by a plurality of optical fibers arranged to form sheets, such that the illumination device emits a luminous flux at all points of an illuminating part of said diffusing light guide.

2. The car body element of claim 1 wherein the diffusing light guide is arranged on a support.

3. The car body element of claim 2, wherein the support is formed by extrusion or by molding from a thermoplastic or elastomeric material, preferably flexible.

4. The car body element of claim 2 wherein the support has a substantially cylindrical shape, and on which the optical fibers of the sheet are arranged along the generatrices.

5. The car body element of claim 1, wherein the diffusing light guide is placed in a recess such that the luminous flux is directed only towards the surface of the body of said motor vehicle adjacent to said recess, and to which surface the license plate is fastened.

6. The car body element of claim 1 wherein the illuminating part of the diffusing light guide extends transversally over a length equal to or greater than a length of said license plate, such that said license plate receives a constant luminous flux over its entire length.

7. The car body element of claim 1 wherein the optical fibers have a diameter of less than 1 mm.

8. The car body element of claim 1 wherein the diffusing light guide is connected at one of its ends to one or more light sources situated on an inner side of the car body element.

9. The car body element of claim 7 wherein the recess comprises a single orifice through which the diffusing light guide passes from the inner side of the car body element to an outer side of said car body element.

10. The car body element of claim 1 wherein the light source is formed by one or more light emitting diodes.

11. The car body element of claim 1 further comprising an opening control device situated in said recess, and extending transversally over the entire length of the illumination device such that said opening control can be actuated at any point of a segment illuminated by the illumination device.

12. The car body element of claim 2 further comprising an opening control device situated in said recess, and extending transversally over the entire length of the illumination device such that said opening control can be actuated at any point of a segment illuminated by the illumination device:
and wherein which the opening control device is assembled on the support.

13. The car body element of claim 11 wherein the opening control device is of a resistive type or an acoustic type.

14. (canceled)

15. The car body element as claimed in claim 1 being a motor vehicle tailgate.

16. The car body element of claim 3 wherein the support has a substantially cylindrical shape, and on which the optical fibers of the sheet are arranged along the generatrices.

17. The car body element of claim 2, wherein the diffusing light guide is placed in a recess such that the luminous flux is directed only towards the surface of the body of said motor vehicle adjacent to said recess, and to which surface the license plate is fastened.

18. The car body element of claim 3, wherein the diffusing light guide is placed in a recess such that the luminous flux is directed only towards the surface of the body of said motor vehicle adjacent to said recess, and to which surface the license plate is fastened.

19. The car body element of claim 4, wherein the diffusing light guide is placed in a recess such that the luminous flux is directed only towards the surface of the body of said motor vehicle adjacent to said recess, and to which surface the license plate is fastened.

20. The car body element of claim 11 wherein the opening control device is of an preferably of optical type

21. The car body element of claim 11 wherein the opening control device is of a capacitive type.

22. The car body element of claim 21 wherein the opening control device is assembled towards an inner part of the tailgate, and in which a material forming said car body element is permeable to electromagnetic fields.

23. The car body element of claim 1 wherein the optical fibers have a diameter of less than or equal to 0.5 mm.
